(19) United States
(12) Patent Application Publication
(10) Pub. No.: US 2024/0206684 A1
(43) Pub. Date: Jun. 27, 2024

(54) Cooking Utensil Assembly

(71) Applicant: Kristin Michaels, La Quinta, CA (US)

(72) Inventor: Kristin Michaels, La Quinta, CA (US)

(21) Appl. No.: 18/085,777

(22) Filed: Dec. 21, 2022

(51) Int. Cl. A47J 43/28

(52) U.S. Cl. CPC A47J 43/281

(57) ABSTRACT

A cooking utensil assembly for visually indentifying the structure of a culinary spoon being stored in a container includes a plurality of spoons which each has a handle and a bowl. The bowl of each of the spoons has a unique structure with respect to each other thereby facilitating each of the spoons to perform a specific culinary task. Each of the spoons has a hole extending through the handle and the hole in the handle of a respective one of the spoons is shaped to match the structure of the bowl of the respective spoon. In this way the hole in the handle of each of the spoons facilitates a user to visually indentify the specific culinary task of which each of the spoons is structured to perform when the plurality of spoons is stored in a container.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to utensil devices and more particularly pertains to a new utensil device for visually indentifying the structure of a culinary spoon being stored in a container. The device includes a plurality of spoons that each has a bowl and a handle. The bowl of each of the spoons has a unique structure with respect to each other and the handle of each of the spoons has a hole. The hole in the handle of a respective spoon is structured to match the shape of the bowl of the respective spoon. In this way the purpose of each of the spoons can be identified with the spoons are stored in a container.

### (2) Description of Related Art Including Information Disclosed Under 37 CFR 1.97 and 1.98

The prior art relates to utensil devices including a variety of spoons that each has a handle that is structurally unique from each other for enhancing gripping and employing the spoons. In no instance does the prior art disclose a spoon which has a hole in a handle of the spoon which matches the shape of a bowl of the spoon for visually identifying the purpose of the spoon when the spoon is being stored in a container.

### BRIEF SUMMARY OF THE INVENTION

An embodiment of the disclosure meets the needs presented above by generally comprising a plurality of spoons which each has a handle and a bowl. The bowl of each of the spoons has a unique structure with respect to each other thereby facilitating each of the spoons to perform a specific culinary task. Each of the spoons has a hole extending through the handle and the hole in the handle of a respective one of the spoons is shaped to match the structure of the bowl of the respective spoon. In this way the hole in the handle of each of the spoons facilitates a user to visually indentify the specific culinary task of which each of the spoons is structured to perform when the plurality of spoons is stored in a container.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top view of a cooking utensil assembly according to an embodiment of the disclosure.

FIG. 2 is a perspective view of an embodiment of the disclosure.

FIG. 3 is a perspective in-use view of an embodiment of the disclosure.

### DETAILED DESCRIPTION OF THE INVENTION

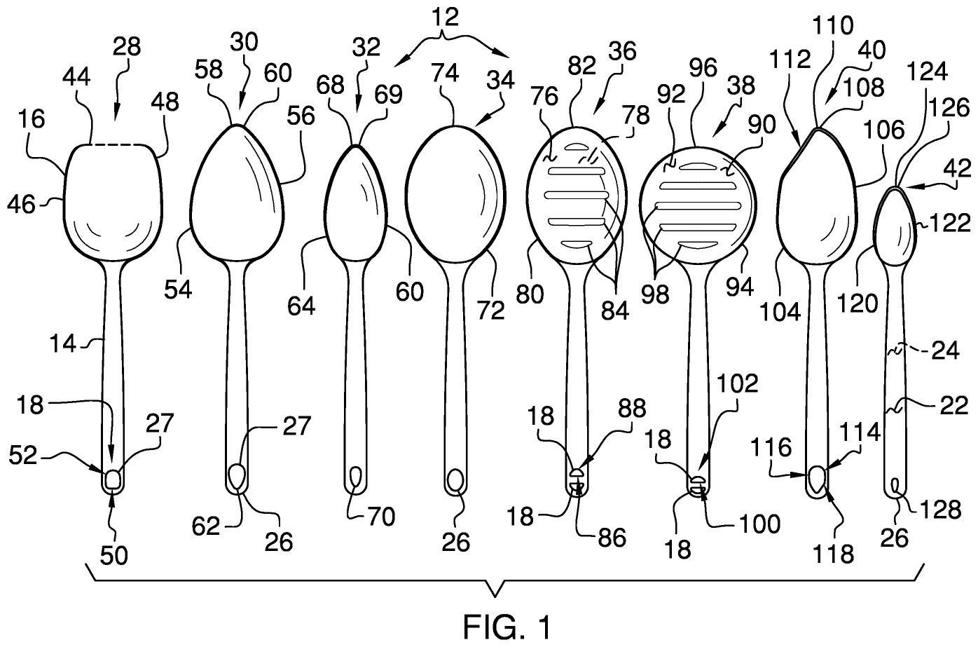

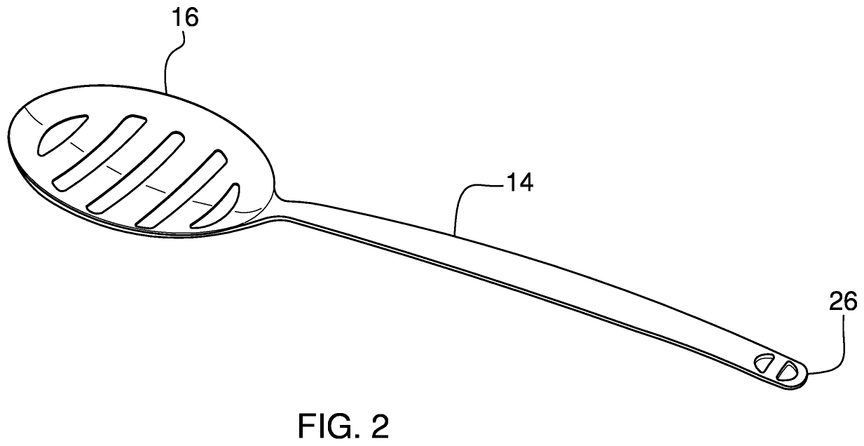

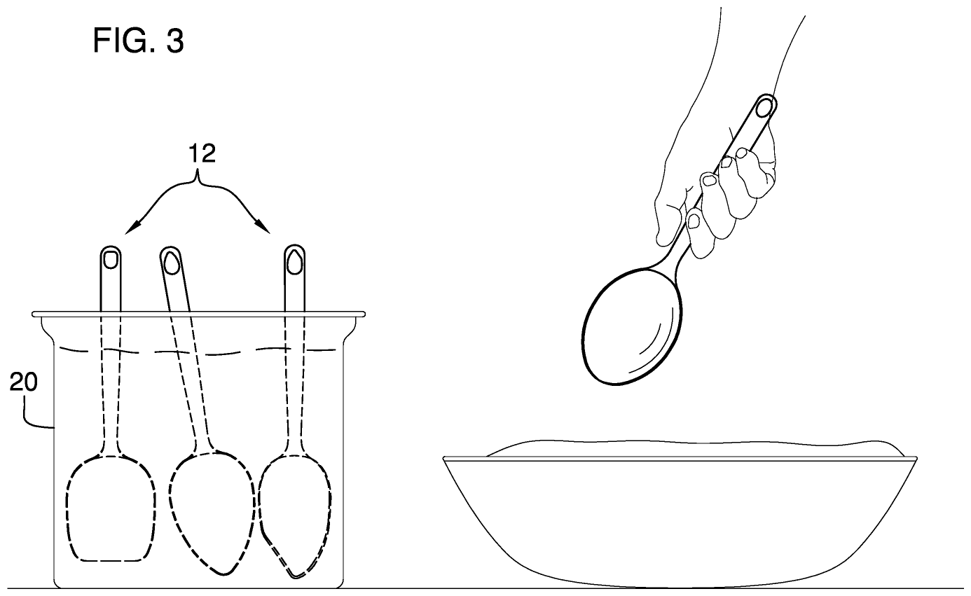

With reference now to the drawings, and in particular to FIGS. 1 through 3 thereof, a new utensil device embodying the principles and concepts of an embodiment of the disclosure and generally designated by the reference numeral 10 will be described.

As best illustrated in FIGS. 1 through 3, the cooking utensil assembly 10 generally comprises a plurality of spoons 12 that each has a handle 14 and a bowl 16. The bowl 16 of each of the spoons 12 has a unique structure with respect to each other thereby facilitating each of the spoons 12 to perform a specific culinary task. Each of the spoons 12 has a hole 18 extending through the handle 14 and the hole 18 in the handle 14 of a respective one of the spoons 12 is shaped to match the structure of the bowl 16 of the respective spoon. In this way a user can visually indentify the specific culinary task of which each of the spoons 12 is structured to perform when the plurality of spoons 12 is stored in a container 20 having the handle 14 of the spoons 12 extending outwardly from the container 20.

The handle 14 of each of the spoons 12 has an upper surface 22, a lower surface 24 and a distal end 26 with respect to the bowl 16 and the hole 18 in the handle 14 of each of the spoons 12 extends through the upper surface 22 and the lower surface 24. The hole 18 is positioned adjacent to the distal end 26 of the handle 14 and the hole 18 in the handle 14 of each of the spoons 12 has a bounding edge 27. The plurality of spoons 12 includes a shovel spoon 28, a teardrop spoon 30, a quenelle spoon 32, a round spoon 34, a slotted round spoon 36, a slotted skimmer spoon 38, an angle spoon 40 and a petite quenelle spoon 42.

The bowl 16 of the shovel spoon 28 has a leading edge 44 extending along a straight line between a first lateral edge 46 and a second lateral edge 48 of the bowl 16 of the shovel spoon 28. The bounding edge 27 of the hole 18 in the handle 14 of the shovel spoon 28 has a first side 50 and a second side 52, and the first side 50 extends along a straight line is oriented perpendicular to a lengthwise axis of the handle 14 of the shovel spoon 28. Furthermore, the second side 52 is concavely arcuate with respect to the first side 50 such that the hole 18 in the handle 14 of the shovel spoon 28 is shaped to resemble the shape of the bowl 16 of the shovel spoon 28.

The bowl 16 of the teardrop spoon 30 has a first lateral edge 54 and a second lateral edge 56 each curving outwardly from a center of the bowl 16 of the teardrop spoon 30 and tapering to a blunt point 58 at a distal end 60 of the bowl 16 of the teardrop spoon 30 with respect to the handle 14 of the teardrop spoon 30. The bounding edge 27 of the hole 18 in the handle 14 of the teardrop spoon 30 is continuously arcuate such that the hole 18 in the handle 14 of the teardrop spoon 30 has a rounded shape. Additionally, the bounding edge 27 of the hole 18 in the handle 14 of the teardrop spoon 30 tapers to a blunt point 62 adjacent to the distal end 26 of the handle 14 of the teardrop spoon 30 such that the hole 18 in the handle 14 of the teardrop spoon 30 is shaped to resemble the shape of the bowl 16 of the teardrop spoon 30.

The bowl 16 of the quenelle spoon 32 has a first lateral edge 64 and a second lateral edge 66 that each curves outwardly from a center of the bowl 16 of the quenelle spoon 32 and tapers to a blunt point 68 at a distal end 69 of the bowl 16 of the quenelle spoon 32 with respect to a handle 14 of the quenelle spoon 32. Each of the first lateral edge 64 and the second lateral edge 66 of the bowl 16 of the quenelle spoon 32 has a radius of curvature that is greater than a radius of curvature of the first lateral edge 54 and the second lateral edge 56 of the bowl 16 of the teardrop spoon 30. The bounding edge 27 of the hole 18 in the handle 14 of the quenelle spoon 32 is continuously arcuate such that the hole 18 in the handle 14 of the quenelle spoon 32 has a rounded shape. The bounding edge 27 of the hole 18 in the handle 14 of the quenelle spoon 32 tapers to a blunt point 70 adjacent to the distal end 26 of the handle 14 of the quenelle spoon 32 such that the hole 18 in the handle 14 of the quenelle spoon 32 is shaped to resemble the shape of the bowl 16 of the quenelle spoon 32.

The bowl 16 of the round spoon 34 has an outer edge 72 that is continuously arcuate about a center of the bowl 16 of the round spoon 34 and the bowl 16 of the round spoon 34 has a distal end 74 with respect to the handle 14 of the round spoon 34. The bowl 16 of the round spoon 34 is elongated between the handle 14 of the round spoon 34 and the distal end 74 of the bowl 16 of the round spoon 34 such that the bowl 16 of the round spoon 34 has an ovoid shape. The bounding edge 27 of the hole 18 in the handle 14 of the round spoon 34 is continuously arcuate such that the hole 18 in the handle 14 of the round spoon 34 has a rounded shape such that the hole 18 in the handle 14 of the round spoon 34 is shaped to resemble the shape of the bowl 16 of the round spoon 34.

The bowl 16 of the slotted round spoon 36 has a top surface 76, a bottom surface 78 and an outer edge 80 and the outer edge 80 of the slotted round spoon 36 is continuously arcuate about a center of the bowl 16 of the slotted round spoon 36. The bowl 16 of the slotted round spoon 36 has a distal end 82 with respect to the handle 14 of the slotted round spoon 36. Additionally, the bowl 16 of the slotted round spoon 36 is elongated between the handle 14 of the slotted round spoon 36 and the distal end 82 of the bowl 16 of the slotted round spoon 36 such that the bowl 16 of the slotted round spoon 36 has an ovoid shape. The bowl 16 of the slotted round spoon 36 has a plurality of slots 84 each extending through the top surface 76 and the bottom surface 78 and each of the slots 84 is elongated to extend laterally across a substantial width of the bowl 16 of the slotted round spoon 36. The slots 84 are spaced apart from each other and are distributed between the handle 14 of the slotted round spoon 36 and the distal end 82 of the bowl 16 of the slotted round spoon 36.

The handle 14 of the slotted round spoon 36 has a pair of the holes 18 and the bounding edge 27 of each of the holes 18 in the handle 14 of slotted round spoon 36 has a first side 86 and a second side 88. The first side 86 of the bounding edge 27 of each of the pair of holes 18 extends along a straight line that is perpendicularly oriented with a lengthwise axis of the handle 14 of the slotted round spoon 36. The second side 88 of the bounding edge 27 of each of the pair of holes 18 is concavely arcuate with respect to the first side 86 of the bounding edge 27 of a respective one of the pair of holes 18. Additionally, the pair of holes 18 is oriented such that the first side 86 of the bounding edge 27 of each of the pair of holes 18 faces each other.

The bowl 16 of the slotted skimmer spoon 38 has a top surface 90, a bottom surface 92 and an outer edge 94 and the outer edge 94 of the slotted skimmer spoon 38 is continuously arcuate about a center of the bowl 16 of the slotted skimmer spoon 38 such that the bowl 16 of the slotted skimmer spoon 38 has a circular shape. The bowl 16 of the slotted skimmer spoon 38 has a distal end 96 with respect to the handle 14 of the slotted skimmer spoon 38. The bowl 16 of the slotted skimmer spoon 38 has a plurality of slots 98 each extending through the top surface 90 and the bottom surface 92 of the bowl 16 of the slotted skimmer spoon 38. Each of the slots 98 associated with the slotted skimmer spoon 38 is elongated to extend laterally across a substantial width of the bowl 16 of the slotted skimmer spoon 38. Additionally, the slots 98 associated with the slotted skimmer spoon 38 are spaced apart from each other and are distributed between the handle 14 of the slotted skimmer spoon 38 and the distal end 26 of the bowl 16 of the slotted skimmer spoon 38.

The handle 14 of the slotted skimmer spoon 38 has a pair of the holes 18 and the bounding edge 27 of each of the holes 18 in the handle 14 of slotted skimmer spoon 38 has a first side 100 and a second side 102. The first side 100 of the bounding edge 27 of each of the pair of holes 18 of the slotted skimmer spoon 38 extends along a straight line that is perpendicularly oriented with a lengthwise axis of the handle 14 of the slotted skimmer spoon 38. Moreover, the second side 102 of the bounding edge 27 of each of the pair of holes 18 of the slotted skimmer spoon 38 is concavely arcuate with respect to the first side 100 of the bounding edge 27 of a respective one of the pair of holes 18 of the slotted skimmer spoon 38. The first side 100 of the bounding edge 27 of each of the pair of holes 18 of the slotted skimmer spoon 38 faces each other.

The bowl 16 of the angle spoon 40 has a first lateral edge 104 and a second lateral edge 106 each curves outwardly from a center of the bowl 16 of the angle spoon 40 and tapers to a blunt point 108 at a distal end 110 of the bowl 16 of the angle spoon 40 with respect to the handle 14 of the angle spoon 40. The first lateral edge 104 of the bowl 16 of the angle spoon 40 has an angled portion 112 extending from the blunt point 108 associated with the bowl 16 of the angle spoon 40 toward the handle 14 of the angle spoon 40. Additionally, the angled portion 112 extends along a straight line. The bounding edge 27 of the hole 18 in the handle 14 of the angle spoon 40 has a primary side 114 and secondary side 116 each curving outwardly from a lengthwise axis of the handle 14 of the angle spoon 40. The primary side 114 has a straightened portion 118 such that the hole 18 in the handle 14 of the angle spoon 40 has a shape that is similar to the shape of the bowl 16 of the angle spoon 40.

The bowl 16 of the petite quenelle spoon 42 has a first lateral edge 120 and a second lateral edge 122 each curving outwardly from a center of the bowl 16 of the petite quenelle spoon 42 and tapering to a blunt point 124 at a distal end 126 of the bowl 16 of the petite quenelle spoon 42 with respect to the handle 14 of the petite quenelle spoon 42. The bowl 16 of the petite quenelle spoon 42 has a length and a width that is less than a length and a width of the bowl 16 of the quenelle spoon 32. The bounding edge 27 of the hole 18 in the handle 14 of the petite quenelle spoon 42 is continuously arcuate such that the hole 18 in the handle 14 of the petite quenelle spoon 42 has a rounded shape. The bounding edge 27 of the hole 18 in the handle 14 of the petite quenelle spoon 42 tapers to a blunt point 128 adjacent to the distal end 26 of the handle 14 of the petite quenelle spoon 42 such that the hole 18 in the handle 14 of the petite quenelle spoon 42 is shaped to resemble the shape of the bowl 16 of the petite quenelle spoon 42.

In use, the spoons 12 are stored in the container 20, which may be a cylinder or other container that might commonly be employed to store the spoons 12 in a kitchen setting. Furthermore the bowl 16 of each of the spoons 12 is positioned in the container 20 having the handle 14 of each of the spoons 12 extending outwardly from the container 20. In this way the hole 18 in the handle 14 of each of the spoons 12 is exposed thereby facilitating the hole 18 in the handle 14 of each of the spoons 12 to be visible. Thus, the shape of the bowl 16 of each of the spoons 12 can be identified by the shape of the hole 18 in the handle 14 in each of the spoons 12. In this way the specific spoon 12 that is desired to perform a specific culinary task can be quickly identified and removed from the container 20.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A cooking utensil assembly including a plurality of spoons with identifying elements in a handle to facilitate the spoons to be visually identified, said assembly comprising:
a plurality of spoons, each of said spoons having a handle and a bowl, said bowl of each of said spoons having a unique structure with respect to each other thereby facilitating each of said spoons to perform a specific culinary task, each of said spoons having a hole extending through said handle, said hole in said handle of a respective one of said spoons being shaped to match said structure of said bowl of said respective spoon wherein said hole in said handle of each of said spoons is configured to facilitate a user to visually indentify the specific culinary task of which each of said spoons is structured to perform when said plurality of spoons is stored in a container.

2. The assembly according to claim 1, wherein:
said handle of each of said spoons has an upper surface, a lower surface and a distal end with respect to said bowl, said hole in said handle of each of said spoons extending through said upper surface and said lower surface, said hole being positioned adjacent to said distal end of said handle, said hole in said handle of each of said spoons having a bounding edge; and
said plurality of spoons includes a shovel spoon, a teardrop spoon, a quenelle spoon, a round spoon, a slotted round spoon, a slotted skimmer spoon, an angle spoon and a petite quenelle spoon.

3. The assembly according to claim 2, wherein:
said bowl of said shovel spoon has a leading edge extending along a straight line between a first lateral edge and a second lateral edge of said bowl of said shovel spoon; and
said bounding edge of said hole in said handle of said shovel spoon has a first side and a second side, said first side extending along a straight line being oriented perpendicular to a lengthwise axis of said handle of said shovel spoon, said second side being concavely arcuate with respect to said first side such that said hole in said handle of said shovel spoon is shaped to resemble the shape of said bowl of said shovel spoon.

4. The assembly according to claim 2, wherein:
said bowl of said teardrop spoon has a first lateral edge and a second lateral edge each curving outwardly from a center of said bowl of said teardrop spoon and tapering to a blunt point at a distal end of said bowl of said teardrop spoon with respect to said handle of said teardrop spoon; and
wherein said bounding edge of said hole in said handle of said teardrop spoon is continuously arcuate such that said hole in said handle of said teardrop spoon has a rounded shape, said bounding edge of said hole in said handle of said teardrop spoon tapering to a blunt point adjacent to said distal end of said handle of said teardrop spoon such that said hole in said handle of said teardrop spoon is shaped to resemble the shape of said bowl of said teardrop spoon.

5. The assembly according to claim 2, wherein:
said bowl of said quenelle spoon has a first lateral edge and a second lateral edge each curving outwardly from a center of said bowl of said quenelle spoon and tapering to a blunt point at a distal end of said bowl of said quenelle spoon with respect to a handle of said quenelle spoon, each of said first lateral edge and said second lateral edge of said bowl of said quenelle spoon having a radius of curvature being greater than a radius of curvature of said first lateral edge and said second lateral edge of said bowl of said teardrop spoon; and
wherein said bounding edge of said hole in said handle of said quenelle spoon is continuously arcuate such that said hole in said handle of said quenelle spoon has a rounded shape, said bounding edge of said hole in said handle of said quenelle spoon tapering to a blunt point adjacent to said distal end of said handle of said quenelle spoon such that said hole in said handle of said quenelle spoon is shaped to resemble the shape of said bowl of said quenelle spoon.

6. The assembly according to claim 2, wherein:
wherein said bowl of said round spoon has an outer edge being continuously arcuate about a center of said bowl of said round spoon, said bowl of said round spoon having a distal end with respect to said handle of said round spoon, said bowl of said round spoon being elongated between said handle of said round spoon and said distal end of said bowl of said round spoon such that said bowl of said round spoon has an ovoid shape; and
wherein said bounding edge of said hole in said handle of said round spoon is continuously arcuate such that said hole in said handle of said round spoon has a rounded shape such that said hole in said handle of said round spoon is shaped to resemble the shape of said bowl of said round spoon.

7. The assembly according to claim 2, wherein:
said bowl of said slotted round spoon has a top surface, a bottom surface and an outer edge, said outer edge of said slotted round spoon being continuously arcuate about a center of said bowl of said slotted round spoon, said bowl of said slotted round spoon having a distal end with respect to said handle of said slotted round spoon, said bowl of said slotted round spoon being elongated between said handle of said slotted round spoon and said distal end of said bowl of said slotted round spoon such that said bowl of said slotted round spoon has an ovoid shape, said bowl of said slotted round spoon having a plurality of slots each extending through said top surface and said bottom surface, each of said slots being elongated to extend laterally across a substantial width of said bowl of said slotted round spoon, said slots being spaced apart from each other and being distributed between said handle of said slotted round spoon and said distal end of said bowl of said slotted round spoon; and
wherein said handle of said slotted round spoon has a pair of said holes, said bounding edge of each of said holes in said handle of slotted round spoon having a first side and a second side, said first side of said bounding edge of each of said pair of holes extending along a straight line being perpendicularly oriented with a lengthwise axis of said handle of said slotted round spoon, said second side of said bounding edge of each of said pair of holes being concavely arcuate with respect to said first side of said bounding edge of a respective one of said pair of holes, said first side of said bounding edge of each of said pair of holes facing each other.

8. The assembly according to claim 2, wherein:
wherein said bowl of said slotted skimmer spoon has a top surface, a bottom surface and an outer edge, said outer edge of said slotted skimmer spoon being continuously arcuate about a center of said bowl of said slotted skimmer spoon such that said bowl of said slotted skimmer spoon has a circular shape, said bowl of said slotted skimmer spoon having a distal end with respect to said handle of said slotted skimmer spoon, said bowl of said slotted skimmer spoon having a plurality of slots each extending through said top surface and said bottom surface of said bowl of said slotted skimmer spoon, each of said slots associated with said slotted skimmer spoon being elongated to extend laterally across a substantial width of said bowl of said slotted skimmer spoon, said slots associated with said slotted skimmer spoon being spaced apart from each other and being distributed between said handle of said slotted skimmer spoon and said distal end of said bowl of said slotted skimmer spoon; and
wherein said handle of said slotted skimmer spoon has a pair of said holes, said bounding edge of each of said holes in said handle of slotted skimmer spoon having a first side and a second side, said first side of said bounding edge of each of said pair of holes of said slotted skimmer spoon extending along a straight line being perpendicularly oriented with a lengthwise axis of said handle of said slotted skimmer spoon, said second side of said bounding edge of each of said pair of holes of said slotted skimmer spoon being concavely arcuate with respect to said first side of said bounding edge of a respective one of said pair of holes of said slotted skimmer spoon, said first side of said bounding edge of each of said pair of holes of said slotted skimmer spoon facing each other.

9. The assembly according to claim 2, wherein:
wherein said bowl of said angle spoon has a first lateral edge and a second lateral edge each curving outwardly from a center of said bowl of said angle spoon and tapering to a blunt point at a distal end of said bowl of said angle spoon with respect to a handle of said angle spoon, said first lateral edge of said bowl of said angle spoon having an angled portion extending from said blunt point associated with said bowl of said angle spoon toward said handle of said angle spoon, said angled portion extending along a straight line; and
wherein said bounding edge of said hole in said handle of said angle spoon has a primary side and secondary side each curving outwardly from a lengthwise axis of said handle of said angle spoon, said primary side having a straightened portion such that said hole in said handle of said angle spoon has a shape that is similar to the shape of said bowl of said angle spoon.

10. The assembly according to claim 2, wherein:
wherein said bowl of said petite quenelle spoon has a first lateral edge and a second lateral edge each curving outwardly from a center of said bowl of said petite quenelle spoon and tapering to a blunt point at a distal end of said bowl of said petite quenelle spoon with respect to a handle of said petite quenelle spoon, said bowl of said petite quenelle spoon having a length and a width being less than a length and a width of said bowl of said quenelle spoon; and
wherein said bounding edge of said hole in said handle of said petite quenelle spoon is continuously arcuate such that said hole in said handle of said petite quenelle spoon has a rounded shape, said bounding edge of said hole in said handle of said petite quenelle spoon tapering to a blunt point adjacent to said distal end of said handle of said petite quenelle spoon such that said hole in said handle of said petite quenelle spoon is shaped to resemble the shape of said bowl of said petite quenelle spoon.

11. A cooking utensil assembly including a plurality of spoons with identifying elements in a handle to facilitate the spoons to be visually identified, said assembly comprising:
a plurality of spoons, each of said spoons having a handle and a bowl, said bowl of each of said spoons having a unique structure with respect to each other thereby facilitating each of said spoons to perform a specific culinary task, each of said spoons having a hole extending through said handle, said hole in said handle of a respective one of said spoons being shaped to match said structure of said bowl of said respective spoon wherein said hole in said handle of each of said spoons is configured to facilitate a user to visually indentify the specific culinary task of which each of said spoons is structured to perform when said plurality of spoons is stored in a container, said handle of each of said spoons having an upper surface, a lower surface and a distal end with respect to said bowl, said hole in said handle of each of said spoons extending through said upper surface and said lower surface, said hole being positioned adjacent to said distal end of said handle, said hole in said handle of each of said spoons having a bounding edge;
wherein said plurality of spoons includes a shovel spoon, a teardrop spoon, a quenelle spoon, a round spoon, a slotted round spoon, a slotted skimmer spoon, an angle spoon and a petite quenelle spoon;
wherein said bowl of said shovel spoon has a leading edge extending along a straight line between a first lateral edge and a second lateral edge of said bowl of said shovel spoon;
wherein said bounding edge of said hole in said handle of said shovel spoon has a first side and a second side, said first side extending along a straight line being oriented perpendicular to a lengthwise axis of said handle of said shovel spoon, said second side being concavely arcuate with respect to said first side such that said hole in said handle of said shovel spoon is shaped to resemble the shape of said bowl of said shovel spoon;
wherein said bowl of said teardrop spoon has a first lateral edge and a second lateral edge each curving outwardly from a center of said bowl of said teardrop spoon and tapering to a blunt point at a distal end of said bowl of said teardrop spoon with respect to said handle of said teardrop spoon;
wherein said bounding edge of said hole in said handle of said teardrop spoon is continuously arcuate such that said hole in said handle of said teardrop spoon has a rounded shape, said bounding edge of said hole in said handle of said teardrop spoon tapering to a blunt point adjacent to said distal end of said handle of said teardrop spoon such that said hole in said handle of said teardrop spoon is shaped to resemble the shape of said bowl of said teardrop spoon;
wherein said bowl of said quenelle spoon has a first lateral edge and a second lateral edge each curving outwardly from a center of said bowl of said quenelle spoon and tapering to a blunt point at a distal end of said bowl of said quenelle spoon with respect to a handle of said quenelle spoon, each of said first lateral edge and said second lateral edge of said bowl of said quenelle spoon having a radius of curvature being greater than a radius of curvature of said first lateral edge and said second lateral edge of said bowl of said teardrop spoon;
wherein said bounding edge of said hole in said handle of said quenelle spoon is continuously arcuate such that said hole in said handle of said quenelle spoon has a rounded shape, said bounding edge of said hole in said handle of said quenelle spoon tapering to a blunt point adjacent to said distal end of said handle of said quenelle spoon such that said hole in said handle of said quenelle spoon is shaped to resemble the shape of said bowl of said quenelle spoon;
wherein said bowl of said round spoon has an outer edge being continuously arcuate about a center of said bowl of said round spoon, said bowl of said round spoon having a distal end with respect to said handle of said round spoon, said bowl of said round spoon being elongated between said handle of said round spoon and said distal end of said bowl of said round spoon such that said bowl of said round spoon has an ovoid shape;
wherein said bounding edge of said hole in said handle of said round spoon is continuously arcuate such that said hole in said handle of said round spoon has a rounded shape such that said hole in said handle of said round spoon is shaped to resemble the shape of said bowl of said round spoon;
wherein said bowl of said slotted round spoon has a top surface, a bottom surface and an outer edge, said outer edge of said slotted round spoon being continuously arcuate about a center of said bowl of said slotted round spoon, said bowl of said slotted round spoon having a distal end with respect to said handle of said slotted round spoon, said bowl of said slotted round spoon being elongated between said handle of said slotted round spoon and said distal end of said bowl of said slotted round spoon such that said bowl of said slotted round spoon has an ovoid shape, said bowl of said slotted round spoon having a plurality of slots each extending through said top surface and said bottom surface, each of said slots being elongated to extend laterally across a substantial width of said bowl of said slotted round spoon, said slots being spaced apart from each other and being distributed between said handle of said slotted round spoon and said distal end of said bowl of said slotted round spoon;
wherein said handle of said slotted round spoon has a pair of said holes, said bounding edge of each of said holes in said handle of slotted round spoon having a first side and a second side, said first side of said bounding edge of each of said pair of holes extending along a straight line being perpendicularly oriented with a lengthwise axis of said handle of said slotted round spoon, said second side of said bounding edge of each of said pair of holes being concavely arcuate with respect to said first side of said bounding edge of a respective one of said pair of holes, said first side of said bounding edge of each of said pair of holes facing each other;
wherein said bowl of said slotted skimmer spoon has a top surface, a bottom surface and an outer edge, said outer edge of said slotted skimmer spoon being continuously arcuate about a center of said bowl of said slotted skimmer spoon such that said bowl of said slotted skimmer spoon has a circular shape, said bowl of said slotted skimmer spoon having a distal end with respect to said handle of said slotted skimmer spoon, said bowl of said slotted skimmer spoon having a plurality of slots each extending through said top surface and said bottom surface of said bowl of said slotted skimmer spoon, each of said slots associated with said slotted skimmer spoon being elongated to extend laterally across a substantial width of said bowl of said slotted skimmer spoon, said slots associated with said slotted skimmer spoon being spaced apart from each other and being distributed between said handle of said slotted skimmer spoon and said distal end of said bowl of said slotted skimmer spoon;
wherein said handle of said slotted skimmer spoon has a pair of said holes, said bounding edge of each of said holes in said handle of slotted skimmer spoon having a first side and a second side, said first side of said bounding edge of each of said pair of holes of said slotted skimmer spoon extending along a straight line being perpendicularly oriented with a lengthwise axis of said handle of said slotted skimmer spoon, said second side of said bounding edge of each of said pair of holes of said slotted skimmer spoon being concavely arcuate with respect to said first side of said bounding edge of a respective one of said pair of holes of said slotted skimmer spoon, said first side of said bounding edge of each of said pair of holes of said slotted skimmer spoon facing each other;
wherein said bowl of said angle spoon has a first lateral edge and a second lateral edge each curving outwardly from a center of said bowl of said angle spoon and tapering to a blunt point at a distal end of said bowl of said angle spoon with respect to a handle of said angle spoon, said first lateral edge of said bowl of said angle spoon having an angled portion extending from said blunt point associated with said bowl of said angle spoon toward said handle of said angle spoon, said angled portion extending along a straight line;
wherein said bounding edge of said hole in said handle of said angle spoon has a primary side and secondary side each curving outwardly from a lengthwise axis of said handle of said angle spoon, said primary side having a straightened portion such that said hole in said handle of said angle spoon has a shape that is similar to the shape of said bowl of said angle spoon;
wherein said bowl of said petite quenelle spoon has a first lateral edge and a second lateral edge each curving outwardly from a center of said bowl of said petite quenelle spoon and tapering to a blunt point at a distal end of said bowl of said petite quenelle spoon with respect to a handle of said petite quenelle spoon, said bowl of said petite quenelle spoon having a length and a width being less than a length and a width of said bowl of said quenelle spoon; and
wherein said bounding edge of said hole in said handle of said petite quenelle spoon is continuously arcuate such that said hole in said handle of said petite quenelle spoon has a rounded shape, said bounding edge of said hole in said handle of said petite quenelle spoon tapering to a blunt point adjacent to said distal end of said handle of said petite quenelle spoon such that said hole in said handle of said petite quenelle spoon is shaped to resemble the shape of said bowl of said petite quenelle spoon.
